(19) United States
(12) Patent Application Publication
(10) Pub. No.: US 2026/0221775 A1
(43) Pub. Date: Jul. 30, 2026

(54) DETERMINING CONFIDENCE TO START VALUES FOR POWER GENERATION SYSTEMS USING MACHINE LEARNING MODELS

(71) Applicant: Cummins Power Generation Limited, London (GB)

(72) Inventor: Andrew William Underwood, Deal (GB)

(73) Assignee: Cummins Power Generation Limited, London (GB)

(21) Appl. No.: 19/143,246

(22) PCT Filed: Dec. 28, 2023
(86) PCT No.: PCT/IB2023/063348

§ 371 Date: Jun. 25, 2025

Related U.S. Application Data
(60) Provisional application No. 63/435,949, filed on Dec. 29, 2022.

(51) Int. Cl. H02J 3/38; G05B 13/02; H02J 103/30

(52) U.S. Cl. CPC H02J 3/38; G05B 13/028; H02J 2103/30

(57) ABSTRACT

Presented herein are systems and methods for applying machine learning (ML) models to determine start confidence values for power generators. The computing system can identify a first plurality of parameters of a first power generator. The plurality of parameters can identify operations of the first power generator. The computing system can apply the first plurality of parameters to a ML model to determine a first confidence value identifying a first likelihood of the first power generator to start upon initiation. The computing system can provide an output based on the first confidence value for the first power generator.

### CROSS REFERENCES TO RELATED APPLICATIONS

The present application claims benefit of priority to U.S. Provisional Patent Application No. 63/435,949, titled “Determining Confidence to Start Values for Gensets Using Machine Learning Models,” filed Dec. 29, 2022, which is incorporated herein by reference in its entirety.

### TECHNICAL FIELD

The present disclosure generally relates to determining predicted performance metrics of devices.

### BACKGROUND

A power generator can convert various forms of energy into electrical power to provide to various loads connected thereto. Due to various factors, the power generator can occasionally become inoperable, and thus unable to provide electrical power to the loads. In certain cases, the power generator may have to be taken out for service by an operator of the system.

### SUMMARY

The present disclosure generally relates to systems and methods for estimating predicted confidence to start values of power generators using machine learning techniques. A machine learning model can be trained using a training dataset of historic performance data aggregated from a multitude of power generators. For each power generator, the training dataset may include measured operational parameters over a time window and an indication of whether the power generator succeeded or failed to start upon initiation. With the establishment of the machine learning model, a computing system can acquire new operational parameters of a power generator. The computing system may apply the new operational parameters to the ML model to generate a confidence value indicating a likelihood that the power generator will successfully start upon initiation.

At least one aspect is directed to a computing system for applying machine learning (ML) models to determine start confidence values for power generators. The computing system can include memory having instructions stored thereon and at least one processor configured to execute the instructions. The at least one processor can identify a first plurality of parameters of a first power generator. The plurality of parameters can identify operations of the first power generator. The at least one processor can apply the first plurality of parameters to a ML model to determine a first confidence value identifying a first likelihood of the first power generator to start upon initiation. The ML model can be trained by: identifying (i) a second plurality of parameters of a second power generator and (ii) an indication of whether the second power generator started upon initiation; determining, by applying the second plurality of parameters to the ML model, a second confidence value identifying a second likelihood of the second power generator to start upon initiation; and updating at least one parameter of the ML model based on a comparison between the second confidence value and the indication. The at least one processor can provide an output based on the first confidence value for the first power generator.

In some embodiments, the at least one processor can provide, responsive to the first confidence value being below a threshold, an alert to indicate that the first power generator is unlikely to start upon initiation. In some embodiments, the at least one processor can initiate, responsive to the first confidence value being below a threshold, a fault clearance measure to increase the first confidence value for the first power generator. In some embodiments, the at least one processor can activate, responsive to the first confidence value being below a threshold, at least one of the second power generator or a third power generator instead of the first power generator to deliver electrical power for an expected load.

In some embodiments, the at least one processor can determine that the confidence value for the first power generator is above a threshold. In some embodiments, the at least one processor can generate a control signal to initiate to the first power generator, responsive to determining that the confidence value for the first power generator is above the threshold. In some embodiments, the at least one processor can determine that the confidence value for the first power generator is below a threshold. In some embodiments, the at least one processor can refrain from generating a control signal to initiate to the first power generator, responsive to determining that the confidence value for the first power generator is below the threshold. In some embodiments, the at least one processor can retrieve data identifying the first plurality of parameters of the first power generator over a time window.

At least one other aspect is directed to a power generation system. The power generation system can include a plurality of power generators. Each of the plurality of power generators can be structured to be coupled with a load. Each of the plurality of power generators can deliver electrical power to the load. The power generation system can include a computing system having one or more processors coupled with memory. The computing system can be in communication with at least one of the plurality of power generators. The computing system can receive a plurality of parameters of the plurality of power generators, the plurality of parameters identifying operations of the plurality of power generators. The computing system can apply the plurality of parameters to a machine learning (ML) model. The computing system can determine, from applying the first plurality of parameters to the ML model, a confidence value identifying a likelihood of the plurality of power generators to start upon initiation. The computing system can generate an output based on the confidence value for the plurality of power generators.

In some embodiments, the computing system can apply the first plurality of parameters to the ML model to generate a respective confidence value for each power generator of the plurality of power generators. In some embodiments, the computing system can generate the confidence value for the plurality of power generators as a function of the respective confidence value for each power generator of the plurality of power generators. In some embodiments, the computing system can determine that the confidence value for the plurality of power generators is above a threshold. In some embodiments, the computing system can generate one or more control signals to initiate to the plurality of power generators, responsive to determining that the confidence value for the plurality of power generators is above the threshold.

In some embodiments, the computing system can determine that the confidence value for the plurality of power generators is below a threshold. In some embodiments, the computing system can identify a second plurality of power generators as available instead of the first power generator to deliver the electrical power to the load, responsive to determining that the confidence value for the plurality of power generators is below the threshold. In some embodiments, the computing system can transmit the output to a remote computing system, the remote computing system configured to communicate with a plurality of groups of power generators structured to be installed across a plurality of sites.

In some embodiments, the plurality of power generators may be structured to be installed at a site, the site comprising at least one of a data center, a microgrid, or a power subsystem. In some embodiments, the plurality of power generators can include at least one of a genset, a fuel cell, a mixed fuel power source, a microgrid, an energy storage, or a renewable power source. In some embodiments, at least one of the plurality of power generators can include a power system comprising a route-based control of one or more objects defined along a plurality of routes in accordance with a one-line topology.

At least one other aspect is directed to directed to a method of configuring power generators based on confidence values. The method can include receiving, by one or more processors, a plurality of parameters of a power generator, the plurality of parameters identifying operations of the power generator prior to initiation of the power generator. The method can include applying, by the one or more processors, the plurality of parameters to a ML model. The ML model can be trained using a training dataset of historic data from a plurality of power generators of a same type as the power generator. The method can include determining, by the one or more processors, from applying the plurality of parameters to the ML model, a confidence value identifying a likelihood of the power generator to start upon initiation. The method can include configuring, by the one or more processors, the power generator based on a comparison between the confidence value and a threshold.

In some embodiments, the method can include determining, by the one or more processors, that the confidence value for the power generator is above a threshold. In some embodiments, configuring the power generator can include causing the power generator to be activated, responsive to determining that the confidence value for the power generator is above the threshold. In some embodiments, the method can include determining, by the one or more processors, that the confidence value for the power generator is below a threshold. In some embodiments, configuring the power generator can include refraining from activating the power generator, responsive to determining that the confidence value for the power generator is below the threshold.

In some embodiments, the method can include identifying, by the one or more processors, the training dataset comprising a plurality of examples corresponding to the plurality of power generators of the same type as the power generator. Each of the plurality of examples can identify: (i) a second plurality of parameters of a respective power generator and (ii) an indication of whether the respective power generator started upon initiation. The method can include applying, by the one or more processors, the second plurality of parameters of each example to the ML model to determine a respective confidence value identifying a likelihood of the respective power generator to start upon initiation. The method can include updating, by the one or more processors, at least one parameter of the ML model based on a comparison between the respective confidence value and the indication of each example of the plurality of examples of the training dataset.

In some embodiments, the ML model can be retrained using the historic data for the training dataset aggregated from the plurality of power generators over a time window, subsequent to a prior training of the ML model using historic data from a previous time window. In some embodiments, the method can include providing, by the one or more processor, information about the power generator for presentation based on the confidence value for the power generator.

### BRIEF DESCRIPTION OF THE DRAWINGS

The disclosure will become more fully understood from the following detailed description, taken in conjunction with the accompanying figures, wherein like reference numerals refer to like elements unless otherwise indicated, in which:

FIG. 1 depicts a block diagram of a power generator system, in accordance with an illustrative embodiment;

FIG. 2 depicts a block diagram of a system for determining start confidence values for power generators, in accordance with an illustrative embodiment;

FIG. 3 depicts a block diagram of an architecture connecting power generator sites with a cloud network to relay data for machine learning (ML) models, in accordance with an illustrative embodiment;

FIG. 4 depicts a block diagram of an architecture for a power generation site with an edge server hosting a trained machine learning (ML) model and interfacing with a local distributor to relay data, in accordance with an illustrative embodiment;

FIG. 5 depicts a block diagram of an architecture for connecting multiple data centers each with trained machine learning (ML) models interfacing with a local distributor to relay data, in accordance with an illustrative embodiment;

FIG. 6 depicts a block diagram of an architecture for determining confidence values across groups of power generators, in accordance with an illustrative embodiment;

FIG. 7 depicts a block diagram of a test environment for aggregating data through cloud services, in accordance with an illustrative embodiment;

FIG. 8 depicts a graph of sampling operational parameters across a time window, in accordance with an illustrative embodiment; and

FIG. 9 depicts a flow diagram of a method of determining start confidence values for power generators, in accordance with an illustrative embodiment.

### DETAILED DESCRIPTION

Following below are more detailed descriptions of various concepts related to, and implementations of, methods, apparatuses, and systems for determining start confidence values for power generators. The various concepts introduced above and discussed in greater detail below may be implemented in any of a number of ways, as the described concepts are not limited to any particular manner of implementation. Examples of specific implementations and applications are provided primarily for illustrative purposes.

Presented herein are systems and methods for determining confidence to start values indicating a predicted likelihood that an individual power generator or a group of power generators at individual sites or across sites will start upon initiation using machine learning models. This system may provide for earlier warning of issues through diagnostic insights into standby machine operation. The confidence to start measures may also allow enhanced insights into operations across fleet trending, machine-to-machine, and site-to-site performance. In addition, use of the machine learning model to ascertain predicted likelihoods of starting may enable a move from fixing upon breakage to zero or near-zero failures in operating the power generators. Even if a failure occurs at one of the power generators, a far detailed and richer set of measurement data may be relied upon to better inform and speed up recovery work. In this manner, various operations of power generators may be optimized and improved. For instance, the fuel and emission impacts on user's operations may be ascertained to adjust operations of the power generator. Furthermore, the use of near-real time machine data rather than chunks of interval data may allow for prediction of finer predictions. Moreover, with the ability to determine whether the power generators will start ahead of time, the downtime of power generators may be reduced and optimized.

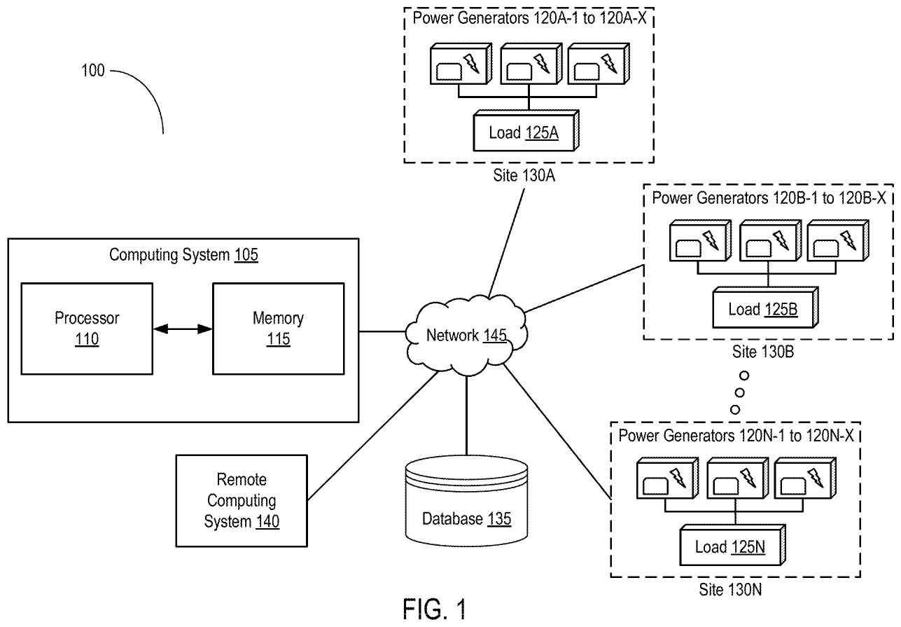

Referring now to FIG. 1, depicted is a block diagram of a power generator system 100. In overview, the system 100 may include at least one computing system 105 (sometimes herein referred to as a server) The computing system 105 can include at least one processor 110 coupled with at least one memory 115. The system 100 can include a set of power generators 120A-1 to 120N-X (hereinafter generally referred to as power generators 120) and a set loads 125 125A-N (hereinafter generally referred to as loads 125) situated across a set of sites 130A-N. At each site 130, a corresponding subset of the power generators 120 can be structured to be coupled with at least one load 125. The system 100 can include at least one database 135 and at least one remote computing system 140. The computing system 105, the set of power generators 120, the set of sites 130, the database 135, the remote computing system 140, may be communicatively coupled with one another via at least one network 145.

Each power generator 120 can transform or convert energy into electrical power to provide or deliver to the load 125. Each power generator 120 can be structured to be coupled with the load 125. Each power generator 120 can provide or deliver the electrical power to the load 125. The set of power generators 120 can include, for example, at least one of: a genset, a fuel cell, a mixed fuel power source, a microgrid, an energy storage, or a renewable power source, among others. The genset may include a combination of a generator and an engine. The engine may convert fuel to mechanical energy and the generator may convert the mechanical energy to electrical energy to provide to various electrical components electrically coupled thereto. The fuel cell can be electrochemical device to converts fuel (e.g., hydrogen) and an oxidizing agent (e.g., oxygen) into the power energy. The fuel cell can include, for example, a proton-exchange membrane fuel cell, a phosphoric acid fuel cell, an alkaline fuel cell, a solid oxide fuel cell, a solid acid fuel cell, or a molten-carbonate fuel cell, among others.

In addition, the mixed fuel power source can be a device or system using multiple types of fuel to generate the electrical power. The mixed fuels can include, for example, a fossil fuel (e.g., natural gas, propane, diesel, or gasoline) and renewable source (e.g., biomass or solar), among others. The microgrid can be a group of electricity sources operating as one or more controllable components. The microgrid can operate independently from a main grid. The energy storage can be an electrical battery pack to store electrical power to release to other components, such as the load. The energy storage can include, for example, lithium-ion batteries, sodium-sulfur battery, lead-acid battery, a nickel-cadmium battery, a lithium iron phosphate battery, among others. The renewable power source can be a device or system using energy derived from naturally replenishable sources, such as solar power, wind power, hydropower, geothermal energy, or biomass, among others.

The power generators 120 (e.g., the set of power generators 120A-1 to 120A-X) can be structured to be secure, situated, or otherwise installed at a given site 130 (e.g., the site 130A). The power generator 120 may be arranged, located, or otherwise situated at least one of the sites 130. The site 130 may correspond to any defined location within which one or more power generators 120 provide power. The site 130 may include or correspond to a data center, a microgrid, or a power subsystem, among others. When serving a data center, the site 130 may include at least one power generator 120 providing power to servers and other computer network equipment within the bounds of the data center. When serving as a microgrid, the site 130 may include at least one power generator 120 providing electrical power to one or more electrical components within a defined boundary of the site 130. When serving a power subsystem, the site 130 may include at least one power generator 120 relaying electrical power to electrical components coupled thereto. In some embodiments, the computing system 105 may be physically situated in at least one of the sites 130, along with one or more power generators 120. In some embodiments, the computing system 105 may be remote from the site 130, and in communication with one or more of the power generators 120 on the site 130.

In some embodiments, at least one of the power generators 120 can include a power system comprising a route-based control of one or more objects defined along a plurality of routes in accordance with a one-line topology. The power system may include source objects (e.g., a grid power connection provided by a utility company, a generator set, a solar array, a battery bank, etc.), bus objects (e.g., source buses, load buses, distribution buses, etc.), transformer objects (e.g., a passive power transformer), switch objects (e.g., automatic transfer switches (ATS), load switches, source switches, circuit breakers, etc.), and controller objects (e.g., source controllers, load bus controllers, switch controllers, etc.). Each object may be assigned an individual object identifier and inserted into a system architecture that can be represented with a one-line topology. Routes may be then defined between each source and each load defined on the one-line topology to establish potential routes for power transfer from sources to loads. The route-based control may include a router function to activate or deactivate routes on the one-line topology via coordination with the source object, the bus object, the switch object, and the load object, among others. In some embodiments, the power generators 120 may be the gensets as described in U.S. patent application Ser. No. 17/155,278 (published as U.S. Pat. App. Pub. No. 2021/0234486), titled “Power System Sequencing Scheme for Any Arbitrary Topology,” filed Jan. 22, 2021, U.S. patent application Ser. No. 17/155,288 (published as U.S. Pat. App. Pub. No. 2021/0234399), titled “Object Based Robust and Redundant Distributed Power System Control,” filed Jan. 22, 2021, and U.S. patent application Ser. No. 17/155,534 (published as U.S. Pat. App. Pub. No. 2021/0234369, filed Jan. 22, 2021, each of which are incorporated herein by reference in their entirety.

The computing system 105 may include at least one computing device or server comprising one or more processors 110 coupled with the memory 115 and software, and capable of performing the various processes and tasks described herein. The processors 110 may include a microprocessor, an application-specific integrated circuit (ASIC), a field-programmable gate array (FPGA), etc., or combinations thereof. The memory 115 include, for example, electronic, optical, magnetic, or any other storage or transmission device capable of providing a processor, ASIC, FPGA, etc. with program instructions. The memory may include a memory chip, Electrically Erasable Programmable Read-Only Memory (EEPROM), Erasable Programmable Read Only Memory (EPROM), flash memory, or any other suitable memory from which the processor of the computing system 105. The instructions may include code from any suitable programming language. The memory may include various modules that include instructions which are configured to be implemented by the processors.

The computing system 105 (and the remote computing system 140) can be in communication with at least one of the power generators 120. The computing system 105 can exchange data with the at least one power generator 120. The at least one power generator 120 can be in communication with other power generators 120 (e.g., at a given site 130) to aggregate, collect, or otherwise receive data from the other power generators 120. The at least one power generator 120 can forward, send, or otherwise transmit the data from the power generators 120 to the computing system 105. Conversely, the at last one power generator 120 can retrieve or receive data from the computing system 105, and forward, send, or otherwise transmit the data from the computing system 105 to the other power generators 120. In some embodiments, the computing system 105 can be in communication with the set of power generators 120 (e.g., at a given site 130 or across the sites 130).

The remote computing system 140 may include at least one computing device or server comprising one or more processors coupled with the memory and software, and capable of performing the various processes and tasks described herein. The processors 110 may include a microprocessor, an application-specific integrated circuit (ASIC), a field-programmable gate array (FPGA), etc., or combinations thereof. The memory 115 include, for example, electronic, optical, magnetic, or any other storage or transmission device capable of providing a processor, ASIC, FPGA, etc. with program instructions. The memory may include a memory chip, Electrically Erasable Programmable Read-Only Memory (EEPROM), Erasable Programmable Read Only Memory (EPROM), flash memory, or any other suitable memory from which the processor of the remote computing system 140. The instructions may include code from any suitable programming language. The memory may include various modules that include instructions which are configured to be implemented by the processors. In some embodiments, the remote computing system 140 may be separate from the computing system 105. In some embodiments, the remote computing system 140 may be separate from the power generators 120 or the sites 130. The remote computing system 140 can be in communication with the computing system 105, the power generators 120, or the sites 130 via the network 145.

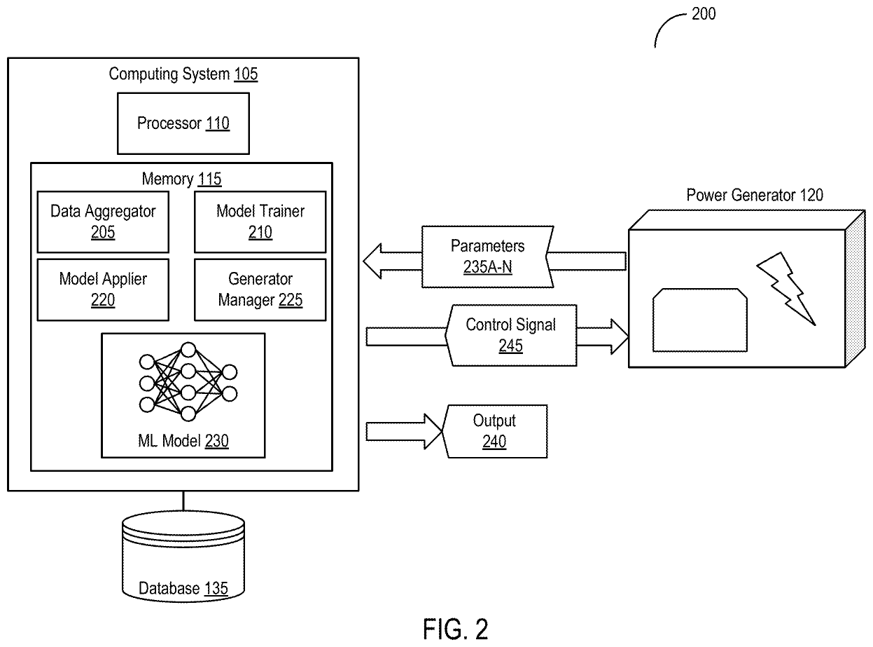

Referring now to FIG. 2, depicted is a block diagram of a system 200 for determining start confidence values for power generators. The system 200 can include the computing system 105, at least one power generator 120, and the database 135, among others. The computing system 105 may include the processor 110 and the memory 115. The memory 115 can have instructions thereon. The instructions on the memory 115 can include at least one data aggregator 205, at least one model trainer 210, at least one model applier 220, at least one generator manager 225, and at least one machine learning (ML) model 230, among others. The power generator 120 can be in communication with the computing system 105. In some embodiments, the power generator 120 can correspond to one structured to be installed at a given site 130. The system 200 can include one or more components of the power generation systems 100 detailed herein.

The computing system 105 itself and the components therein, such as the data aggregator 205, the model trainer 210, the model applier 220, the generator manager 225, and the ML model 230, may have a training mode and an inference model (sometimes herein referred to as an evaluation or runtime mode). In brief, under the training mode, the computing system 105 may invoke the model trainer 210 to train the ML model 230 using a labeled training dataset from one or more second power generators 120. Under the inference mode, the computing system 105 may apply newly acquired data from one or more first power generators 120 to the ML model 230. In some embodiments, the ML model 230 may have been trained and established on a separate computing device and then provided to the computing system 105.

Under the training mode, the data aggregator 205 executing on the computing system 105 may aggregate, collect, or otherwise receive data from the power generators 120 situated across one or more of the sites 130 to train the ML model 230. The plurality of power generators 120 may be of the same type as the power generator 120 for which the predicted confidence value is to be generated using newly acquired data. For example, if the historic data are taken from fuel cells, the ML model 230 can be trained to determine predicted confidence values of other fuel cells using newly acquired data. In some embodiments, the data aggregator 205 may access the site 130 (e.g., a microprocessor on the power generator 120 at the site 130) to retrieve, fetch, or otherwise obtain the data about the power generators 120 (e.g., at the site 130). In some embodiments, the data aggregator 205 may accept or receive the data from the power generators 120. For example, due to data controls at a particular site 130, the data aggregator 205 may not be able to access the power generators 120 at the site 130. Instead, a computing device at the site 130 may periodically provide, send, or transmit the data to the computing system 105.

For each power generator 120, the data may include or identify: a second plurality of parameters identifying operations of the second power generator 120; and an indication of whether the second power generator 120 started upon indication, among others. The data aggregator 205 can retrieve, receive, or otherwise identify the second plurality of parameters of a second power generator 120 and the indication of whether the second power generator 120 started upon indication. The second plurality of parameters may identify operations of the second power generator 120. In some embodiments, the data may include parameters and indication for a group of second power generators 120. The data may also identify the second power generator 120 (e.g., using a device identifier) or the group (e.g., using a group identifier). The data may be organized, structured, or otherwise arranged in field-value pairs for corresponding sampling time instances. The second plurality of parameters may identify numerical measurements for various operational characteristics about the second power generator 120, such as: voltage and current measurement data (e.g., by phase, A-phase, B-Phase, and C-phase); engine data (e.g., fuel pressure, fuel consumption, temperature, and rotations per minute); health (e.g., battery health, lifetime, motor condition, coolant system, and lubrication); maintenance or inspection status; output power (e.g., generator power); and environmental factors (e.g. weather, humidity, and temperature), among others, over a respective time window.

Continuing on, the time window may be between a pair of successive sampling time instances. The time window for the data may range between a few seconds to days (e.g., 15 seconds to 30 days). For each sampling time instance, the indication of the data may identify whether the second power generator 120 was properly operating (e.g., successful start or continued operations) or was failed at proper operations (e.g., failed at started or break down). The indication may be, for example, a Boolean value identifying one of the two operational states (e.g., successful or failure to start upon initiation) for the second power generator 120. Upon receiving, the data aggregator 205 may store and maintain the data onto the database 150. When gathered under the training mode, the data aggregator 205 may add or include the data as a training dataset to be used for training the ML model 230. The data aggregator 205 may continue to accumulate the data from the second power generators 120 for the training dataset.

The model trainer 210 executing on the computing system 105 may initiate or establish the ML model 230 using the training dataset stored on the database 150. The ML model 230 may be any machine learning (ML) model to estimate, calculate, or determine a confidence value indicating a likelihood of one or more gensets to start upon initiation. The ML model used to implement the ML model 230 may include, for example, an artificial neural network (ANN), a Bayesian network, a random forest, a regression model, or a support vector machine (SVM), among others. In general, the ML model 230 may have a set of inputs and a set of outputs related to each other by a set of weights arranged in accordance with the model architecture. The inputs may include the second plurality of parameters identifying the operations of the second power generator 120 (or a group of second power generators 120). The output may include a confidence value indicating likelihood that the second power generator 120 (or the group of second power generators 120) will start upon initiation.

In initializing, the model trainer 210 may set or assign the set of weights of the ML model 230 to initial values (e.g., pseudo-random values). Furthermore, the model trainer 210 may access the database 150 to retrieve, obtain, or otherwise identify the training dataset. The training dataset may include or identify the second plurality of parameters identifying operations of a given second power generator 120 (or group of second power generators 120); and the indication of whether the second power generator 120 started upon indication, as discussed above. In some embodiments, the training dataset may include a plurality of examples. Each example may include or identify (i) a second plurality of parameters of a respective power generator and (ii) an indication of whether the respective power generator started upon initiation. With the identification, the model trainer 210 may convey, relay, or otherwise provide the training dataset to the model applier 220.

The model applier 220 executing on the computing system 105 may apply the second plurality of parameters from the training dataset to the ML model 230 to calculate, generate, or otherwise determine a second confidence value. In applying, the model applier 220 may feed the second plurality of parameters as inputs to the ML model 230. Upon feeding, the model applier 220 may process the one or more input parameters in accordance with the set of weights of the ML model 230. For instance, when the ML model 230 is implemented using an artificial neural network (ANN), the model applier 220 may process the input parameters using the set of weights connected across layers of the ANN according to the model architecture. From processing using the weights of the ML model 230, the model applier 130 may output, produce, or otherwise generate the second confidence value. The second confidence value may identify the likelihood that the second power generator 120 (or group of second power generators 120) with the set of operational parameters will successfully start upon initiation. The second confidence value may be numerical measure (e.g., ranging between 0 and 1, −1 to 1, 0 to 100, or −100 to 10) corresponding to the likelihood.

Upon applying the second plurality of parameters from the training dataset, the model trainer 210 may compare the output second confidence values from the ML model 230 with the indication from the training dataset for the given second power generator 120. In comparing, the model trainer 210 may calculate, generate, or otherwise determine at least one loss metric. The loss metric may indicate a degree of discrepancy between the output second confidence value of the ML model 230 versus the measured indication of whether the second power generator 120 started or failed upon initiation. The loss metric may be calculated in accordance with any number of loss functions, such as a Huber loss, norm loss (e.g., L1 or L2), mean squared error (MSE), a quadratic loss, and a cross-entropy loss, among others. In general, the greater the loss metric, the more inaccurate the predictions from the ML model 230 may be. Conversely, the lower the loss metric, the more accurate the predictions from the ML model 230 may be.

In some embodiments, the model trainer 210 may convert the output second confidence value to an intermediate value to compare with the indication, prior to determination of the loss metric. To determine the intermediate value, the model trainer 210 may determine whether the second confidence value satisfies a threshold. The threshold may correspond to a value for the second confidence value at which the corresponding second power generator 120 is predicted to have successfully started or failed to start upon initiation. If the second confidence value satisfies (e.g., greater than or equal to) the threshold, the model trainer 210 may determine that the ML model 230 has identified that the second power generator 120 will successfully start upon initiation. The model trainer 210 may also set or assign a value indicating prediction of successful start. In contrast, if the second confidence value does not satisfy (e.g., less than) the threshold, the model trainer 210 may determine that the ML model 230 has identified that the second power generator 120 will fail at starting upon initiation. The model trainer 210 may also set or assign a value indicating prediction of a failure to start. Using these intermediate values, the model trainer 210 may compare with the indication and may calculate the loss metric as discussed above.

Based on the comparison between the second confidence value and the indication, the model trainer 210 may reconfigure, modify, or update at least one weight of the ML model 230. In some embodiments, the model trainer 210 may update the weights of the ML model 230 using the loss metric. The updating of the weights may be, for example, in accordance with an optimization function (e.g., stochastic gradient descent or adaptive moment estimation) defining rates and other constraints at which values for the weights are to be adjusted. The model trainer 210 may repeat the process of iteratively training the ML model 230 upon convergence (e.g., loss metrics not changed by a threshold over successive training epochs). When convergence is reached, the model trainer 210 may switch the operation mode of the computing system 105 from training mode to the inference mode.

In some embodiments, the model trainer 210 can modify, update, or otherwise retrain the ML model 230 any number of times. In some embodiments, the ML model 230 can be retrained using historic data aggregated from the plurality of power generators 120 over a time window. The time window can be subsequent to a prior training (e.g., a previous epoch) of training of the ML model 230 using historic data from the previous time window. The retraining can be a repetition of the training of the ML model 230 as detailed herein. For instance, the historic data can also include a second plurality of parameters identifying operations of the second power generator 120; and an indication of whether the second power generator 120 started upon indication, among others. The model applier 220 can apply the second plurality of parameters from the new training dataset to the ML model 230 to determine another second confidence value. The model trainer 210 can update one or more weights of the ML models 230 based on a comparison between the second confidence value and the indication from the new historic data.

Under the inference mode, the data aggregator 205 may aggregate, collect, or otherwise receive newly acquired data from the first power generator 120 (or a group of first power generators 120). In some embodiments, the data aggregator 205 may retrieve, identify, or otherwise receive the data from the site 130 at which the first power generator 120 is situated. The collection of the new data under the inference mode may be similar to the gathering of data as discussed above with respect to the training dataset under the training mode. The newly acquired data may include or identify set of parameters identifying operations of each first power generator 120 (or a group of first power generators 120).

In some embodiments, the data aggregator 205 may retrieve, receive, or otherwise identify a first plurality of parameters 235A-N (hereinafter generally referred to as first plurality of parameters 235) of a first power generator 120. In some embodiments, the data aggregator 205 may retrieve, receive, or otherwise identify a first plurality of parameters 235 of a plurality (or group) of power generators 120. The identification can be prior to the initiation, start, or activation of the power generator 120 (or the plurality of power generators 120). In some embodiments, the data may include a first plurality of parameters 235 indication for a given group of first power generators 120. The parameters may be acquired by the first power generators 120 at the sites 130 and by extension the data aggregator 205, prior to the initiation of the first power generators 120. When acquired before attempting to start the first power generators 120, the data may lack any indication of whether the first power generator 120 started upon indication.

The data may be organized, structured, or otherwise arranged in field-value pairs for corresponding sampling time instances. For instance, the first plurality of parameters 235 may identify numerical measurements for various operational characteristics about the first power generator 120, such as: voltage and current measurement data (e.g., by phase, A-phase, B-Phase, and C-phase); engine data (e.g., fuel pressure, fuel consumption, temperature, and rotations per minute); health (e.g., battery health, lifetime, motor condition, coolant system, and lubrication); maintenance or inspection status; output power (e.g., generator power); and environmental factors (e.g. weather, humidity, and temperature), among others, over a respective time window. The time window for the data may range between a few seconds to days (e.g., 15 seconds to 30 days). The data may be collected over a set number of sampling time instances (e.g., 1 to 100 samples) corresponding number of time windows relative to the present time. In some embodiments, the data aggregator 205 can retrieve data identifying the first plurality of parameters 235 over a time window.

With the identification, the model applier 220 may apply the first plurality of parameters 235 the ML model 230 to calculate, generate, or otherwise determine a confidence value for the first power generator 120 (or group of first power generators 120). In some embodiments, the model applier 220 may apply the first plurality of parameters 235 of the plurality of power generators 120 to the ML model 230. The ML model 230 can be trained using the training dataset of historic data from a plurality of power generators 120 of a same type as the first power generator 120. For example, if the historic data are taken from a group of gensets, the ML model 230 can be used to determine predicted confidence values of other gensets using newly acquired data. In applying, the model applier 220 may feed the first plurality of parameters 235 as inputs to the ML model 230. Upon feeding, the model applier 220 may process the one or more input parameters in accordance with the set of weights of the ML model 230. From processing using the weights of the ML model 230, the model applier 130 may output, produce, or otherwise generate the first confidence value. The first confidence value may identify the first likelihood of the first power generator 120 (or group of first power generators 120) with the parameters to successfully start upon initiation. The first confidence value may be numerical measure (e.g., ranging between 0 and 1, −1 to 1, 0 to 100, or −100 to 10) corresponding to the likelihood.

In some embodiments, the model applier 220 may, from applying the first plurality of parameters 235 to determine the first confidence value identifying the likelihood of the plurality of power generators to start upon initiation. The group may include or correspond to the power generators 120 at a particular site 130 or across multiple sites 130. The parameters may identify operations of the group of first power generators 120. In some embodiments, the model applier 220 may apply the parameters aggregated from the power generators 120 in the group to the ML model 230. The application of the parameters may be similar as above. From applying, the model applier 220 may determine the first confidence value for the overall plurality (or group) of power generators 120. In some embodiments, the model applier 220 may determine the first confidence value for the plurality of power generators 120 as a function the first confidence value for each of the power generators 120. The function may be, for example, a weighted summation or average of the first confidence values of all the first power generators 120 in the group.

The generator manager 225 executing on the computing system 105 may send, transmit, or otherwise provide at least one output 240 based on the first confidence value for the first power generator 120 (or group of first power generators 120). In some embodiments, the generator manager 225 may output, produce, or otherwise generate the output 240 based on the first confidence value. In some embodiments, the generator manager 225 may output, produce, or otherwise generate information based on the first confidence value. The output 240 may indicate or identify the first confidence value for the first power generator 120. In some embodiments, the output 240 may include the first plurality of parameters for the first power generator 120 used to generate the output. The output 240 may be displayed or presented on a computing device communicatively coupled with the computing system 105, such as the computing device associated with the site 130. In some embodiments, the output 240 may be rendered on a display connected with the computing system 105. In some embodiments, the generator manager 225 can provide, send, or otherwise transmit the output 240 to a remote computing system 140. The remote computing system 140 can communicate with groups of power generators 120 structured to be installed across the plurality of sites 130.

In some embodiments, the generator manager 225 may generate the output 240 based on a comparison of the first confidence value with a threshold. The threshold may identify or define a value for the first confidence value at which to trigger a particular type of action associated with the first power generator 120 (or the plurality of power generators 120). When the first confidence value is determined to exceed the threshold, the generator manager 225 may generate the output 240 to indicate the first power generator 120 as properly functioning, healthy, or otherwise likely to start upon initiation. Otherwise, when the first confidence value is determined to be below the threshold, the generator manager 225 may generate an alert to indicate that the first power generator 120 is nonoperational, not healthy, or otherwise unlikely to start upon initiation.

In some embodiments, the generator manager 225 may determine or identify whether to carry out, perform, or otherwise initiate a fault clearance measure on the power generator 120 (or the group) based on the comparison between the first confidence value and the threshold. The fault clearance measure may include one or more actions to improve or increase the operational parameters of the power generator 120. For example, the fault clearance measure may include adjusting the fuel pressure, changing output voltage, or modifying resistance of a variable resistor on the load of the power generator 120 at the site 130, among others. When the first confidence value is determined to exceed the threshold, the generator manager 225 may determine not to initiate the fault clearance measure. Conversely, when the first confidence value is determined to be below the threshold, the generator manager 225 may initiate the fault clearance measure for the power generator 120.

In some embodiments, the generator manager 225 may set, modify, or otherwise configure the first power generator 120 (or the plurality or group of power generators 120) based on the first confidence value. In some embodiments, the generator manager 225 may configure the first power generator 120 (or the plurality or group of first power generators 120) based on a comparison between the first confidence value and a threshold. The threshold may identify or indicate a value for the first confidence value at which to trigger modifications of the configuration of the first power generator 120 (or the plurality of power generators 120). In some embodiments, the generator manager 225 may determine whether to start the first power generator 120 based on the comparison between the first confidence value and the threshold.

If the first confidence value is determined to exceed the threshold, the generator manager 225 may determine that the first power generator 120 as properly functioning, healthy, or otherwise likely to start upon initiation. In some embodiments, the generator manager 225 may initiate, start, or otherwise activate the first power generator 120 (or the plurality or group of power generators 120). In some embodiments, the generator manager 225 can output, produce, or otherwise generate at least one control signal 245 to initiate to the first power generator 120, responsive to determining that the confidence value for the first power generator is above the threshold. In some embodiments, the generator manager 225 can output, produce, or otherwise generate one or more control signals 245 to initiate to the plurality (or group) of power generators 120. The generator manager 225 can transmit the control signal 245 to the first power generator 120 to initiate, start, or otherwise activate the first power generator 120. The first power generator 120 in turn can execute, carry out, or otherwise perform initiation upon receipt of the control signal 245.

In contrast, if the first confidence value is determined to be below the threshold, the generator manager 225 may determine that the first power generator 120 as nonoperational, not in healthy state, or otherwise likely to start upon initiation. The generator manager 225 may refrain from generating a control signal to initiate the first power generator 120 (or group or plurality of power generators 120), responsive to determining that the confidence value for the first power generator is below the threshold. The generator manager 225 may provide the information indicating the determination. In some embodiments, the generator manager 225 can output, produce, or otherwise generate at least one control signal 245 to halt or prevent initiation of the first power generator 120, responsive to determining that the confidence value for the first power generator is below the threshold. In some embodiments, the generator manager 225 can output, produce, or otherwise generate one or more control signals 245 to halt or prevent initiation of the plurality (or group) of power generators 120. The generator manager 225 can transmit the control signal 245 to the first power generator 120 to prevent initiation, starting, or otherwise activation of the first power generator 120. The first power generator 120 in turn can execute, carry out, or otherwise perform initiation upon receipt of the control signal 245.

In some embodiments, when the first confidence value for the power generator 120 (or group or plurality of power generators) is below the threshold, the generator manager 225 may determine or identify whether another power generator 120 is available instead of the power generator 120 to deliver power for an expected load. The expected load can correspond to the load 125 to be electrically coupled with the power generators 120. The expected load can also correspond to the load 125 currently electrically coupled with the power generators 120 that have yet to be activated. In determining, the generator manager 225 may identify the first confidence values of other power generators 120 at the same site 130 or able to deliver power to the site 130. From the power generators 120, the generator manager 225 may identify a subset of power generators 120 with first confidence values exceeding the threshold. With the identification, the generator manager 225 may determine whether there are any power generators 120 in the subset with an output capacity fulfilling the expected load. If there are none, the generator manager 225 may identify that there are no power generators 120 available.

On the other hand, if there one or more, the generator manager 225 may identify at least one third power generator 120 as available instead of the first power generator 120 with the unsatisfactory first confidence value. In some embodiments, the generator manager 225 may identify at least one of the second power generator 120 or a third power generator 120 as available instead of the first power generator 120 to deliver electrical power for the expected load. The second power generator 120 can correspond to one of the power generators 120 whose historic data was used to train the ML model 230. With the identification, the generator manager 225 can. In some embodiments, the generator manager 225 can initiate, start, or otherwise activate at least one of the second power generator 120 or a third power generator 120 instead of the first power generator 120, responsive to the first confidence value of the first power generator 120 being below the threshold. In some embodiments, the generator manager 225 may identify a second plurality (or group) of power generators 120 instead of the plurality (or group) of power generators 120 as available to deliver the electrical power to the load 125. In some embodiments, the generator manager 225 can initiate, start, or otherwise activate a second plurality (or group) of power generators 120 instead of the plurality (or group) of power generators 120, responsive to the first confidence value of the plurality or power generators 120 being below the threshold, the generator manager 225 may provide the information to include the identification of the other power generators 120.

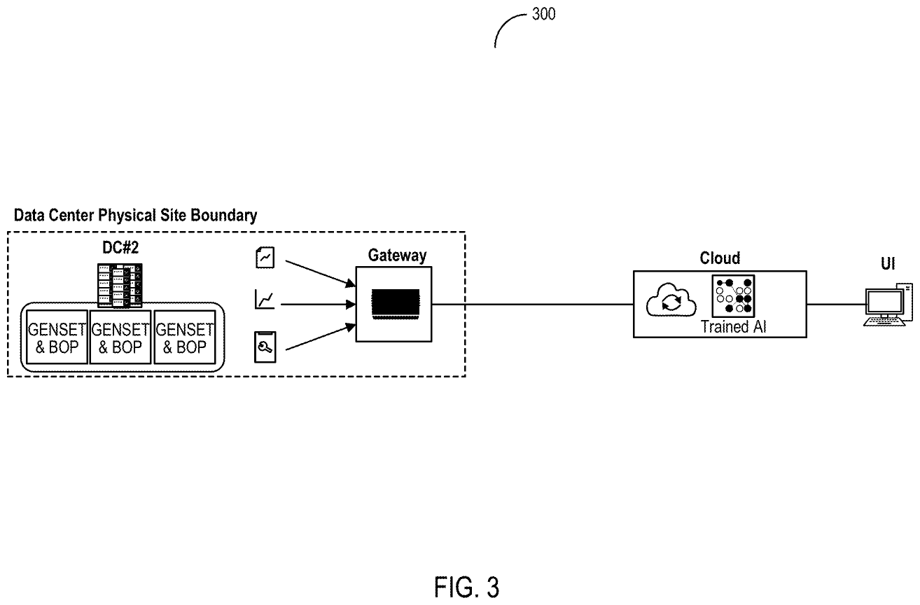

Referring now to FIG. 3, depicted is a block diagram of an architecture 300 for connecting genset sites with a cloud network to relay data for machine learning (ML) models. As depicted, the architecture may include a gateway at the physical site with the gensets to gather and aggregate data to provide to a cloud service. The cloud service may include the trained model to process the data to provide results for presentation on a graphical user interface. This architecture may enable fleet-wide connectivity and could functionality, as well as fleet wide configuration and functionality itself.

Furthermore, the architecture may provide for remote connectivity facilitating greater distributor intimacy with the generator installations and greater oversight. This in turn may enable distributor to better meet the requirements of the contracted Service Level Agreements (SLA). The remote connectivity may also allow for automation and quick turnaround in deploying model updates for improved accuracy. There may also be potential to securely up-train models based on multiple end user's data for improved accuracy while maintaining separation of the end users' data.

Regarding the configuration, the on-site gateway may connect with the cloud service. The cloud service may maintain ownership of the data in the tenancy of cloud network. The cloud service may provide for the data pipelines, datasets, prediction inferences, dashboards, reports, and end user facing application. The trained models may reside in a tenancy of cloud service.

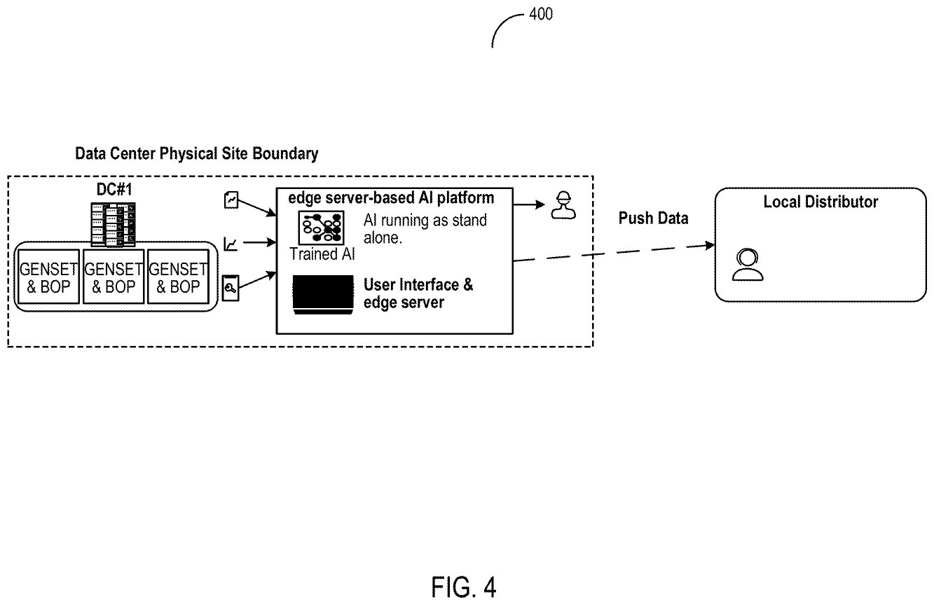

Referring now to FIG. 4, depicted is a block diagram of an architecture 400 for a genset site with an edge server hosting a trained machine learning (ML) model and interfacing with a local distributor to relay data. As depicted, the architecture may include an edge server at the physical site to gather data from the one or more gensets. The edge server may also host the trained model for processing the collected data, and may periodically (e.g., weekly or monthly) push the gathered data to a local distributor network.

The architecture (also referred herein as a fully-air gapped setup) may be suited for sites where no continuous physical connection is permitted to retrieve the data about the gensets from the site. This may result in updates to the ML model being scheduled. Regarding configuration, the on-site edge server may be equipped with a local application with a user interface to inform the on-site service team. The edge connected device may run a trained ML model pushed to the site by the local distributor. By arrangement, the data from the site may be pushed to the local distributor on a regular basis.

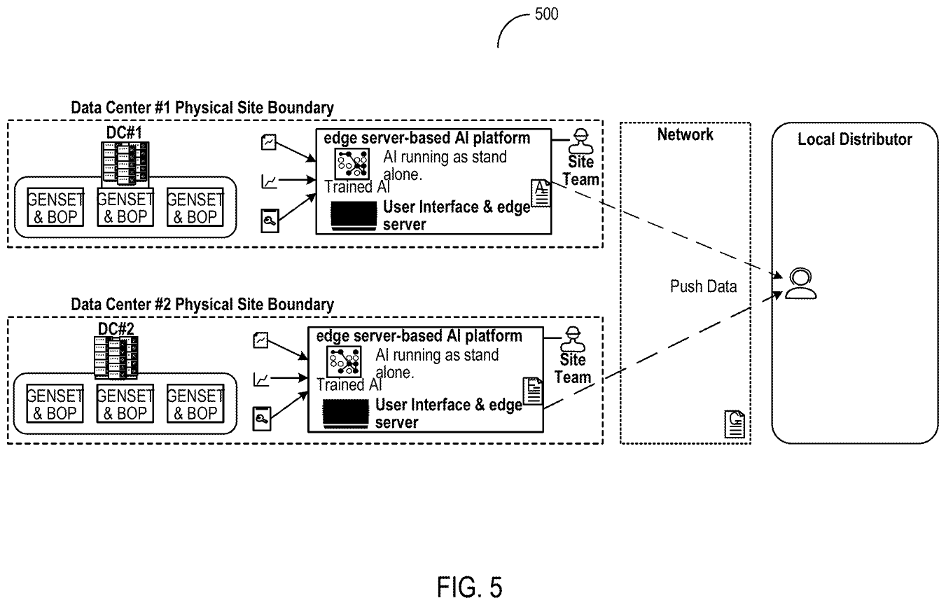

Referring now to FIG. 5, depicted is a block diagram of an architecture 500 for connecting multiple data centers each with trained machine learning (ML) models interfacing with a local distributor to relay data. As depicted, the architecture may include multiple data centers, each with an edge server hosting a trained ML model to process data to generate confidence to start values. An indication of a confidence to start derived from generator and balance of plant historic operation and system status. The ML model may generate an indication for each generator, each site, and the overall global fleet.

In addition, the confidence to start indicator for each generator or site may provide added insight into standby system readiness that can be used to, compare generator to generator, site to site, and current status or site or generator to historic position. In doing so, the operator of the gensets at a particular site can understand and investigate potential issues prior to such issues causing any disruption and also gain more insight into system readiness based on operating regimes.

Regarding configuration, an edge server-based platform may be installed within each site fully air-gapped and behind a firewall at the site. This may provide on-site maintenance team indication and tracking of “confidence to start” for each generator and balance of plant and each site as an enhancement of the network. Data from each site may be pushed to the local distributor of the trained ML model regularly. This data may be evaluated as part of a health-check under and accompanying service level agreements.

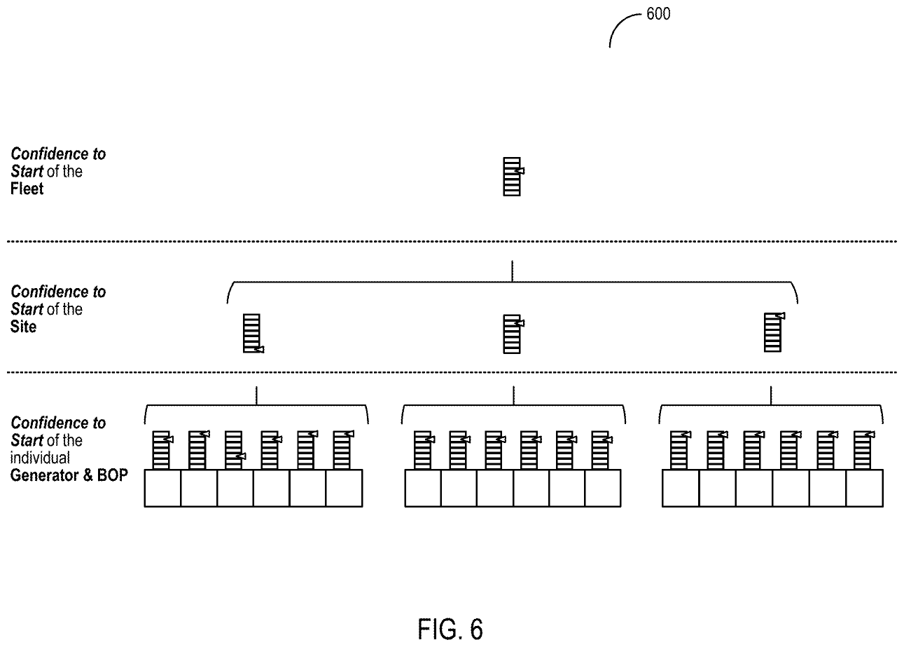

Referring now to FIG. 6, depicted is a block diagram of an architecture 600 for determining confidence values across a group of gensets. As depicted, the gensets may be arranged individually (generally along bottom), by site (generally along the middle), and by entire fleet of gensets (generally along top of figure), among others. An indication of confidence to start may be derived from generator and balance of plant historic operation and system status using the ML model. The model may be used to generate indication for each generator, each site, and the overall global fleet. The indication may be in scaled output or different resolutions.

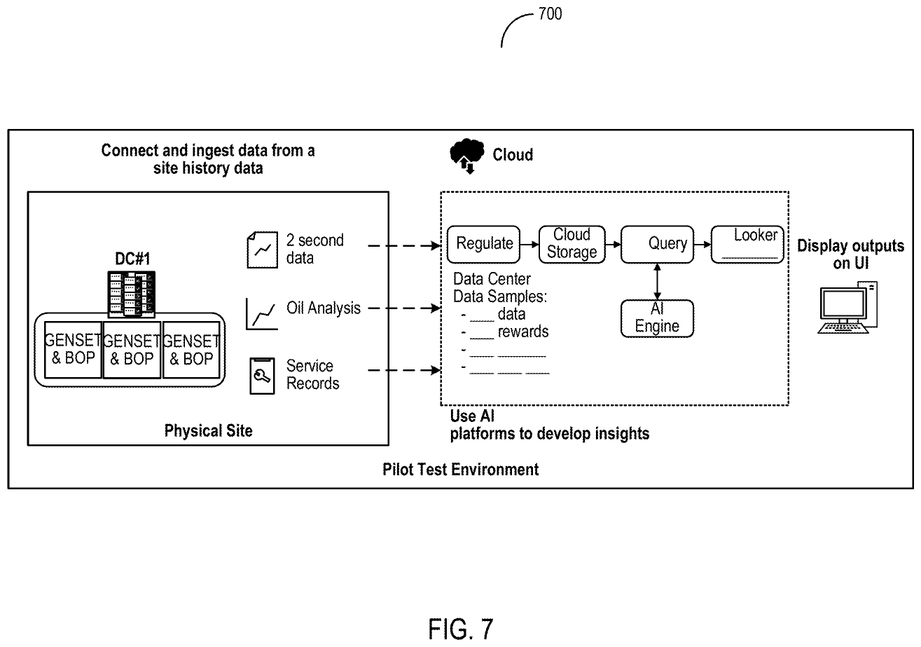

Referring now to FIG. 7, depicted is a block diagram of a test environment 700 for aggregating data through cloud services. As depicted, the test environment may include a physical site with one or more gensets and a cloud service to process the data. The physical site may be used to aggregate genset-related data, oil analysis, and service records over a period of time (e.g., 1 to 15 years). The cloud service may connect with the physical site and ingest the history data. With the retrieval of the data, the cloud service may train a machine learning (ML) model to determine confidence values, among other metrics. Information relating to the output of the ML model may be displayed on a graphical user interface.

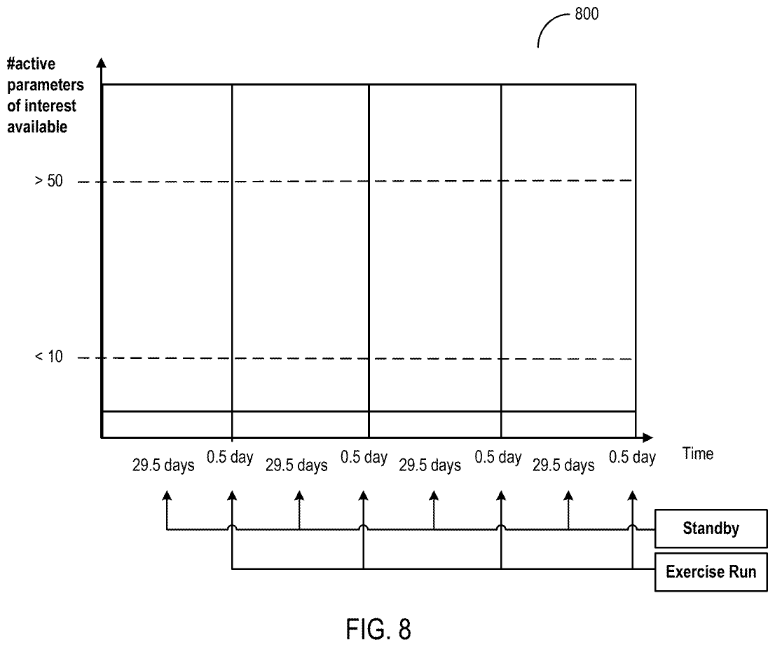

Referring now to FIG. 8 depicts a graph 800 of sampling operational parameters across a time window. In context, the cloud service may gather comprehensive data from multiple sites with one or more gensets that provide power for the respective sites. The number of active parameters of interest that are available may vary depending on whether the genset machines are standby or performing an exercise run. In standby operation, approximately 25 parameters may be gathered. In exercise run operation, about 100 parameters may be collected. The service may gather any number of parameters. For example, as enumerated in Table 1 below, there may be 17 analog parameters, 17 digital parameters, and 6 alarm parameters from the aggregation of the data from the sites.

TABLE 1

| Point Name | Low/High Limits | Units | Description |
|---|---|---|---|
| Vll ab | 0-416/480 +− 10% | V | Volts line to line Phase A-B |
| Vll bc | 0-416/480 +− 10% | V | Volts line to line Phase B-C |
| Vll ca | 0-416/480 +− 10% | V | Volts line to line Phase C-A |
| Vll a | 0-416/480 +− 10% | V | Volts line to neut Phase A |
| Vll b | 0-416/480 +− 10% | V | Volts line to neut Phase B |
| Vll c | 0-416/480 +− 10% | V | Volts line to neut Phase C |
| l a | depends on the model | A | Current Phase A |
| | specs | | |
| l b | | A | Current Phase B |
| l c | | A | Current Phase C |
| Bat Volt | | V (dc) | Battery Voltage |
| Oilpres | | PSI | Engine Oil Pressure |
| Oil temp | | PSI | Engine Oil Temperature |
| Cooltemp | | PSI | Engine Coolant Temp |
| Engspeed | | RPM | Engine Speed (RPM) |
| Engstarts | | Number | Number of Engine Starts |
| | | of Starts | |
| Engine | | Hrs | Engine Run Time (Hours) |
| Runtime | | | |
| EngFuelrate | | GPH | Engine Fuel Compensation Rate |
| LoFuel Lvl | | | Lo Fuel Level Alarm/1 = Alarm |
| kVAR_Tot | | | GEN Volt Amps Reactive |
| OverSpeed | | | Engine Overspeed Alarm/1 = Alarm |
| LoOilPre | | | Lo Oil Pressure Alarm/1 = Alarm |
| HiEngTemp | | | Hi Engine Temperature/1 = Alarm |
| LowCoolTemp | | | Lo Coolant Temperature Alarm/1 = Alarm |
| FailToStart | | | Engine Failed to Start/1 = Alarm |
| ChargACFail | | | Charger AC Source Failed/1 = Alarm |
| NotInAuto | | | Not in Auto Alarm/1 = Alarm |
| Engine | | | Engine Running Status/1 = Alarm |
| Running | | | |
| SuppLoad | | | Engine Able to Support Load/1 = Alarm |
| Check Genset | | | Check Engine Alarm/1 = Alarm |
| EStop | | | Emergency Stop Active/1 = Alarm |
| Total kwh | | kWh | Total Hourly Consumer kW |
| TotalFuel | | Gal | Accumulative Fuel Consumed |
| KW % | | % | Generator KW % |
| KW_TOT | | kw | Total generator KW |

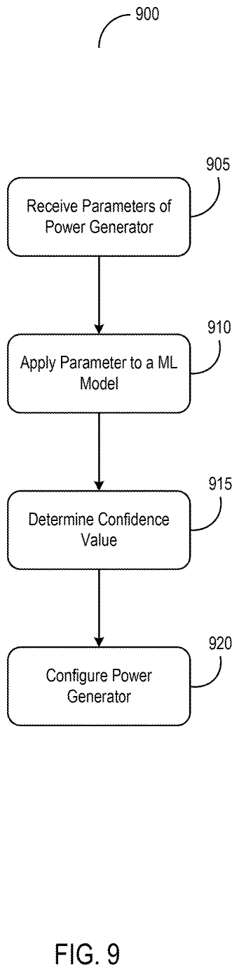

Referring now to FIG. 9, depicts a flow diagram of a method 900 of determining start confidence values for power generators. The method 900 may be implemented using or performed by any of the components discussed herein above, such as the computing system 105 or the power generators 120. In brief overview, under the method 900, one or more processors may receive a plurality of parameters of a power generator (905). The one or more processors may apply the plurality of parameters to a machine learning (ML) model (910). The one or more processors may determine a confidence value (915). The one or more processors may configure the power generator (920).

In further detail, one or more processors may retrieve, identify, or otherwise receive a plurality of parameters of a power generator (905). The plurality of parameters identifying operations of the power generator prior to initiation of the power generator. In some embodiments, the one or more processors may identify the plurality of parameters for multiple power generator from one or more sites. The plurality of parameters may identify operations of the genset, such as: voltage and current measurement data (e.g., by phase, A-phase, B-Phase, and C-phase); engine data (e.g., fuel pressure, fuel consumption, temperature, and rotations per minute); health (e.g., battery health, lifetime, motor condition, coolant system, and lubrication); maintenance or inspection status; output power (e.g., generator power); and environmental factors (e.g. weather, humidity, and temperature), among others, over a respective time window.

The one or more processors may apply the plurality of parameters to a machine learning (ML) model (910). The ML model may have a set of weights relating the inputs with the outputs. The one or more processors may feed the parameters received from the genset into the ML model and processing the input in accordance with the set of weights. The ML model may be trained using a training dataset of historic data from a plurality of power generators of a same type as the power generator. To train, the one or more processors may identify the training dataset comprising a plurality of examples corresponding to the plurality of power generators of the same type as the power generator. Each of the plurality of examples may identify: (i) a second plurality of parameters of a respective power generator and (ii) an indication of whether the respective power generator started upon initiation. The one or more processors may apply the second plurality of parameters of each example to the ML model to determine a respective confidence value identifying a likelihood of the respective power generator to start upon initiation. The one or more processors may update at least one parameter of the ML model based on a comparison between the respective confidence value and the indication of each example of the plurality of examples of the training dataset. In some embodiments, the ML model may be retrained using the historic data for the training dataset aggregated from the plurality of power generators over a time window, subsequent to a prior training of the ML model using historic data from a previous time window.

The one or more processors may calculate, generate, or otherwise determine, from applying the plurality of parameters to the ML model, a confidence value identifying a likelihood of the power generator to start upon initiation (915). In some embodiments, the one or more processors may determine the confidence value identifying a likelihood of the plurality of power generators to start upon initiation. The confidence value for the plurality of power generators may be determined as a function of the confidence value for each power generator of the plurality of power generators. In some embodiments, the one or more processors may determine the confidence value by applying the plurality of parameters aggregate across the plurality of power generators.

The one or more processors may set, manage, or otherwise configure the power generator based on a comparison between the confidence value and a threshold (920). In some embodiments, the one or more processors may configure the plurality of power generators based on the comparison between the confidence value for the plurality of power generators and the threshold. The threshold may identify or indicate a value for the confidence value at which to trigger modifications of the configuration of the power generator(s). In some embodiments, the one or more processors may determine that that the confidence value for the power generator is above a threshold. The one or more processors may configure the power generator by causing the power generator to be activated, responsive to determining that the confidence value for the power generator is above the threshold. In some embodiments, the one or more processors may determine that the confidence value for the power generator is below a threshold. The one or more processors may configure the power generator by refraining from activating the power generator, responsive to determining that the confidence value for the power generator is below the threshold.

In some embodiments, the one or more processors may provide information about the power generator for presentation based on the confidence value for the power generator. The information may identify the confidence value of the power generator. The provision of the information may be based on a comparison between the confidence value and a threshold. For instance, if the confidence value of the power generator is below the threshold, the one or more processors may provide an alert informing an operator of the state of the power generator. In some embodiments, the one or more processors may perform one or more actions based on the confidence value. For example, when the confidence value of the power generator is below a threshold, the one or more processors may initiate measures to improve the operational characteristics of the power generator.

While this specification contains various implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components, or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, exhaust gas, hydrocarbon, an air-hydrocarbon mixture, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values herein are inclusive of their maximum values and minimum values unless otherwise indicated. Furthermore, a range of values does not necessarily require the inclusion of intermediate values within the range of values unless otherwise indicated.

It is important to note that the construction and arrangement of the various systems and the operations according to various techniques shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

What is claimed is:

1. A computing system for applying machine learning (ML) models to determine start confidence values for power generators, comprising:
memory having instructions stored thereon; and
at least one processor configured to execute the instructions to:
identify a first plurality of parameters of a first power generator, the plurality of parameters identifying operations of the first power generator;
apply the first plurality of parameters to a ML model to determine a first confidence value identifying a first likelihood of the first power generator to start upon initiation, wherein the ML model is trained by:
identifying (i) a second plurality of parameters of a second power generator and (ii) an indication of whether the second power generator started upon initiation;
determining, by applying the second plurality of parameters to the ML model, a second confidence value identifying a second likelihood of the second power generator to start upon initiation; and
updating at least one parameter of the ML model based on a comparison between the second confidence value and the indication;
provide an output based on the first confidence value for the first power generator.

2. The computing system of claim 1, wherein the at least one processor is configured to execute the instructions to provide, responsive to the first confidence value being below a threshold, an alert to indicate that the first power generator is unlikely to start upon initiation.

3. The computing system of claim 1, wherein the at least one processor is configured to execute the instructions to initiate, responsive to the first confidence value being below a threshold, a fault clearance measure to increase the first confidence value for the first power generator.

4. The computing system of claim 1, wherein the at least one processor is configured to execute the instructions to activate, responsive to the first confidence value being below a threshold, at least one of the second power generator or a third power generator instead of the first power generator to deliver electrical power for an expected load.

5. The computing system of claim 1, wherein the at least one processor is configured to execute the instructions to:
determine that the confidence value for the first power generator is above a threshold; and
generate a control signal to initiate to the first power generator, responsive to determining that the confidence value for the first power generator is above the threshold.

6. The computing system of claim 1, wherein the at least one processor is configured to execute the instructions to:
determine that the confidence value for the first power generator is below a threshold; and
refrain from generating a control signal to initiate to the first power generator, responsive to determining that the confidence value for the first power generator is below the threshold.

7. The computing system of claim 1, wherein the at least one processor is configured to execute the instructions to retrieve data identifying the first plurality of parameters of the first power generator over a time window.

8. A power generation system, comprising:
a plurality of power generators, each of the plurality of power generators structured to be coupled with a load, each of the plurality of power generators configured to deliver electrical power to the load; and
a computing system having one or more processors coupled with memory, the computing system in communication with at least one of the plurality of power generators, the computing system configured to:
receive a plurality of parameters of the plurality of power generators, the plurality of parameters identifying operations of the plurality of power generators;
apply the plurality of parameters to a machine learning (ML) model;
determine, from applying the first plurality of parameters to the ML model, a confidence value identifying a likelihood of the plurality of power generators to start upon initiation; and
generate an output based on the confidence value for the plurality of power generators.

9. The power generation system of claim 8, wherein the computing system is further configured to:
apply the first plurality of parameters to the ML model to generate a respective confidence value for each power generator of the plurality of power generators; and
generate the confidence value for the plurality of power generators as a function of the respective confidence value for each power generator of the plurality of power generators.

10. The power generation system of claim 8, wherein the computing system is further configured to:
determine that the confidence value for the plurality of power generators is above a threshold; and
generate one or more control signals to initiate to the plurality of power generators, responsive to determining that the confidence value for the plurality of power generators is above the threshold.

11. The power generation system of claim 8, wherein the computing system is further configured to:
determine that the confidence value for the plurality of power generators is below a threshold; and
identify a second plurality of power generators as available instead of the first power generator to deliver the electrical power to the load, responsive to determining that the confidence value for the plurality of power generators is below the threshold.

12. The power generation system of claim 8, wherein the computing system is further configured to transmit the output to a remote computing system, the remote computing system configured to communicate with a plurality of groups of power generators structured to be installed across a plurality of sites.

13. The power generation system of claim 8, wherein the plurality of power generators are structured to be installed at a site, the site comprising at least one of a data center, a microgrid, or a power subsystem, and
wherein the plurality of power generators comprises at least one of a genset, a fuel cell, a mixed fuel power source, a microgrid, an energy storage, or a renewable power source.

14. The power generation system of claim 8, wherein at least one of the plurality of power generators comprises a power system comprising a route-based control of one or more objects defined along a plurality of routes in accordance with a one-line topology.

15. A method of configuring power generators based on confidence values, comprising:
receiving, by one or more processors, a plurality of parameters of a power generator, the plurality of parameters identifying operations of the power generator prior to initiation of the power generator;
applying, by the one or more processors, the plurality of parameters to a ML model, wherein the ML model is trained using a training dataset of historic data from a plurality of power generators of a same type as the power generator;
determining, by the one or more processors, from applying the plurality of parameters to the ML model, a confidence value identifying a likelihood of the power generator to start upon initiation; and
configuring, by the one or more processors, the power generator based on a comparison between the confidence value and a threshold.

16. The method of claim 15, further comprising determining, by the one or more processors, that the confidence value for the power generator is above a threshold, and
wherein configuring the power generator further comprises causing the power generator to be activated, responsive to determining that the confidence value for the power generator is above the threshold.

17. The method of claim 15, further comprising determining, by the one or more processors, that the confidence value for the power generator is below a threshold, and
wherein configuring the power generator further comprises refraining from activating the power generator, responsive to determining that the confidence value for the power generator is below the threshold.

18. The method of claim 15, further comprising:
identifying, by the one or more processors, the training dataset comprising a plurality of examples corresponding to the plurality of power generators of the same type as the power generator, each of the plurality of examples identifying: (i) a second plurality of parameters of a respective power generator and (ii) an indication of whether the respective power generator started upon initiation;
applying, by the one or more processors, the second plurality of parameters of each example to the ML model to determine a respective confidence value identifying a likelihood of the respective power generator to start upon initiation; and
updating, by the one or more processors, at least one parameter of the ML model based on a comparison between the respective confidence value and the indication of each example of the plurality of examples of the training dataset.

19. The method of claim 15, wherein the ML model is retrained using the historic data for the training dataset aggregated from the plurality of power generators over a time window, subsequent to a prior training of the ML model using historic data from a previous time window.

20. The method of claim 15, further comprising providing, by the one or more processor, information about the power generator for presentation based on the confidence value for the power generator.
